(19) United States
(12) Patent Application Publication
(10) Pub. No.: US 2012/0020253 A1
(43) Pub. Date: Jan. 26, 2012

(54) Method for Providing an International Number Transfer Service and Device

(76) Inventor: Bankim B. Brahmbhatt, (US)

(21) Appl. No.: 13/170,183

(22) Filed: Jun. 28, 2011

(30) Foreign Application Priority Data
Jul. 1, 2010 (IN) 1926/MUM/2010

(51) Int. Cl. H04W 4/16

(52) U.S. Cl. 370/259

(57) ABSTRACT

A system and method for extending international roaming voice call services at cost effective rates which provides by enhancing the world wide mobility of Incoming and Outgoing voice call services on long distance calls at very nominal usage charges without losing the real number which is the soul identity of the person as his family, friends, relatives and business are familiar with his own number which is now possible by use of a novel and unique Bridge2Call (B2C) switch system apparatus having a brain in form of computer software application which also provide many associated services and at the same time provides new customer base to the operator partners in international market without making expenses behind infrastructure and advertisement to create the global market.

### CROSS REFERENCES

The present application is a continuation of my Indian Application Ser. No. 1926/MUM/2010 filed Jul. 1, 2010. The application is incorporated herein by this reference which is not admitted to be prior art with respect to the present invention by its mention in the background. It is incorporated in this reference to give a priority date with respect to the present invention.

### FIELD OF INVENTION

A need has arisen to increase the speed of delivery of information transmitted through the telephony and mobile service industries in a cost efficient manner in the telecommunication industry. International calling boundaries have been blurred by the rapid evolution of telecommunication technologies.

This invention is a novel communication solution that allows its users to maintain one number throughout the world and that further allows each user to initiate their own international calling card service via the number, regardless of wherein they are physically present.

### BACKGROUND

Presently, roaming facilities are available to international travelers when traveling through foreign countries. When an individual moves to a new country from a country wherein he or she is being provided a specific radio frequency telephone service, using a distinct number from his home country, he or she normally will have to purchase a new card from the switch operators of the particular country to keep connected while remaining in the new country. A problem arises when the individual is provided with the new card to receive the services in the new country, for the individual will not be able to keep his or her original number. This causes problems to the individual and all of his or her contacts that contacted the original number. From this point forward the individual shall be referred as the roamer.

The present invention allows the roamer to remain connected to his or her contacts using his or her distinct number, when in foreign territories, in a cost efficient manner. Presently, some phones are able to roam into foreign territories in a cost prohibitive manner. The present invention also allows the roamers to connect to their contacts in their the home country, when in a foreign country, by allowing them to dial their home country code from their telephones even though the card they are using uses a different code than the one being used by the new country operators.

The present invention is a novel system that allows the roamer to roam internationally, using the roamer's home specific phone number, via incoming and outgoing calls, in a cost efficient manner, and that further allows the roamer the ability to start an international calling card service. The present invention also allows the roamer to maintain one telephone number throughout the World, thereby allowing him to communicate with all his or her contacts in a manner that will not disrupt his or her business or personal life.

### SUMMARY

The present invention is a novel system that allows a roamer to roam internationally, using the roamer's home specific phone number, via incoming and outgoing calls, in a cost efficient manner, and that further allows the roamer the ability to start an international calling card service. The novelty of the present invention is that the roamer doesn't lose his real number, which is the roamers connection to his or her family, friends, relatives and business, when traveling outside of the roamer's home country.

An object of the present invention is to provide a unique worldwide telecommunication service that provides international roaming services to users by enhancing the mobility of their incoming and outgoing voice calls at very nominal usage charges.

Another object of the present invention is to create an efficient long distance telecommunication service that will blur international boundaries in a cost efficient manner.

A further object of the present invention is to create a complete platform that would allow its operators to initiate and create their own retail calling card businesses.

Still a further object of the present invention is to provide a unique thread that international roaming facilities may avail when connecting to the users of the thread, thereby reducing the costs of roaming when the users are not in the home country wherein the thread originated, the unique thread being associates to a specific telephone number.

### DRAWINGS

For more complete understanding regarding the novelty and uniqueness of the present invention, reference should now be had to embodiments illustrated in exhaustive detail in attached drawings and described below by way of illustrative examples of the invention:

FIG. 1 shows a schematic diagram that shows how a roamer using the present invention would activate the present invention in a foreign country or territory;

FIG. 2 shows a schematic diagram how an incoming call would be routed to a roamer when in a foreign country;

FIG. 3 shows a schematic diagram how an outgoing call would be made by the roamer;

FIG. 4 shows a schematic of how the roamer would use a mapped outbound access number (MOAN) to make and execute the long distance call;

FIG. 5 shows a schematic of how the roamer can program some elements of the present invention; and

FIG. 6 shows a diagram of the infrastructure/architecture of the present invention.

### DESCRIPTION

The present invention is a unique and novel method and system of providing incoming and outgoing roaming services which give rise to thread a unique method with the adoption of a novel system apparatus through which the roaming facility may avail by adopting a method in form of a software application which is a subordinate to the system apparatus.

Various assisting parameters forming the mechanism of the present invention consist of a software program that helps reduce the usage cost, provide more efficient services, and possibly create business opportunities to roamers using the present invention when in foreign countries or territories. The novel system and method (apparatus with software program) is not only addition but the alternative of the present roaming services being provided worldwide. The present invention should eventually make present roaming services being practiced obsolete.

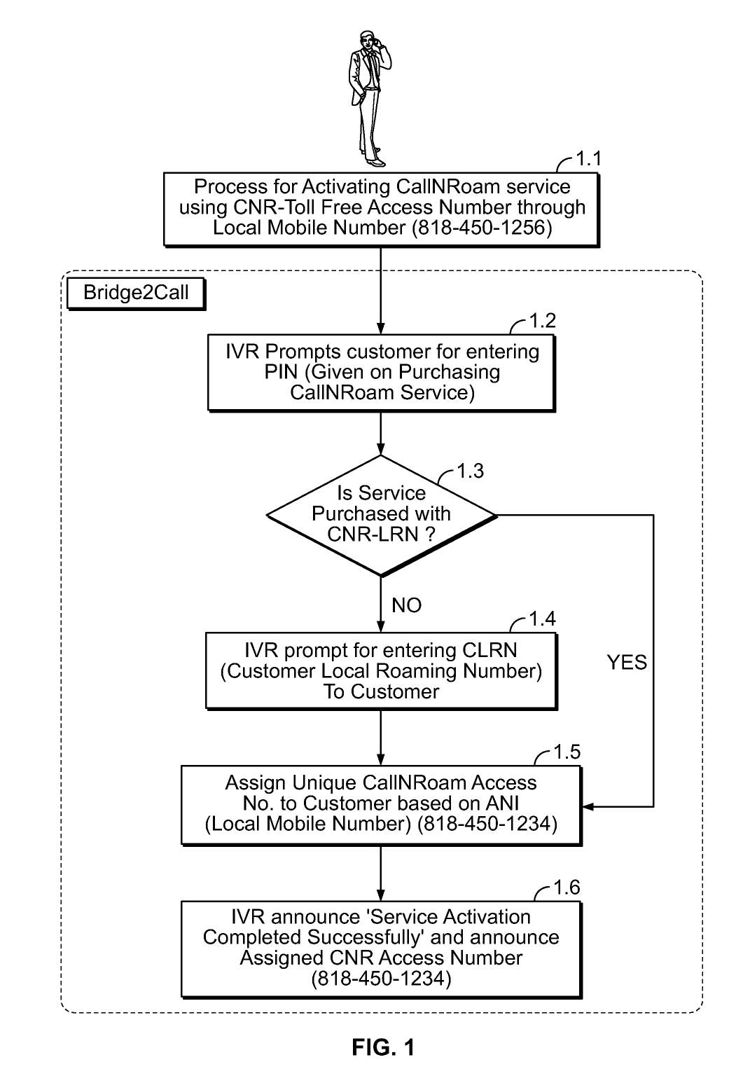

FIGS. 1-5 are schematic diagrams of the present invention that show how the present invention is practiced. The present invention will result in reduction of charges presently incurred by roamers when roaming and will create a global roaming retail market for local operators in foreign territories. Allowing local operators to reduce costs by using the present inventions infrastructure will allow local operators to compete with larger companies, and thereby will reduce the costs that roamers will incur when in foreign territories.

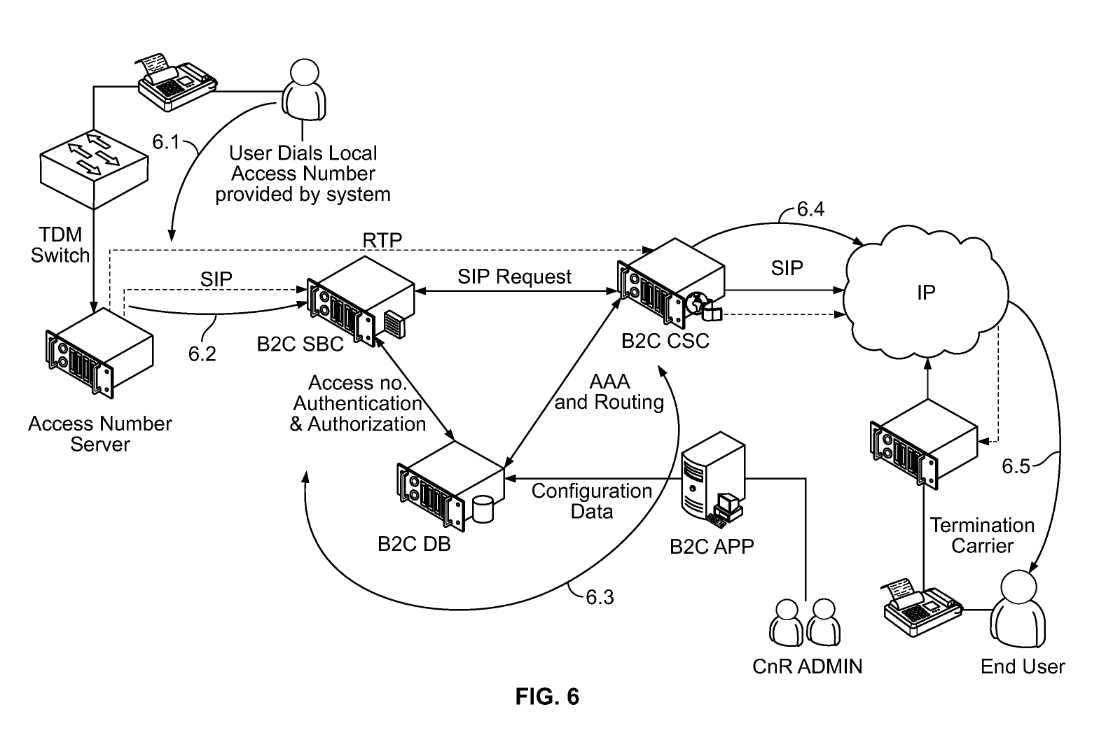

FIG. 6 shows a diagram of an international number transfer service device. the device comprises: a user interface; a TDM switch that connects to the user interface; an access number server that connects to the TDM switch; a system having an SBC (session border controller), a database, a call session controller, and an application that manages the roamers unique identifier, the system connects to the TDM switch; and a termination carrier that connect to the system.

FIG. 1 shows how a roamer would activate the present invention. The activation of the service is numerically described as follows:
1.1 Roamer dials on CallNRoam Toll Free access number using his/her Local Mobile Number for activating CallNRoam service after purchasing service. For example,
Local Mobile Number of Roamer is: 818-450-1256
Home Network: US
1.2 Dialing on CallNRoam Toll Free Access (CNRTFAN), IVR activated and prompts roamer for entering PIN number, that is the 12 digits number that will be given to roamer when CallNRoam service purchased by roamer.
1.3 Bridge2Call switch authenticate PIN and if PIN authentication successes then
If roamer purchase CallNRoam services without CallNRoam-Local Roaming Number (CNR-LRN) then flow directed to ‘1.4’ and then in sequence.
If roamer purchase services with CallNRoam service CallNRoam-Local Roaming Number (CNR-LRN) then flow directed to ‘1.5.’
1.4 IVR activated and prompts roamer for entering Local Roaming Number.
1.5 CallNRoam assign unique CallNRoam-Service Access Number (CNR-SAC) to roamer, e.g. Assigned CNR-SAC: 818-450-1234
1.6. IVR activated and announce ‘Service activation completed Successfully’ and assigned CallNRoam-Service Access Number (CNR-SAC) i.e. 818-450-1234

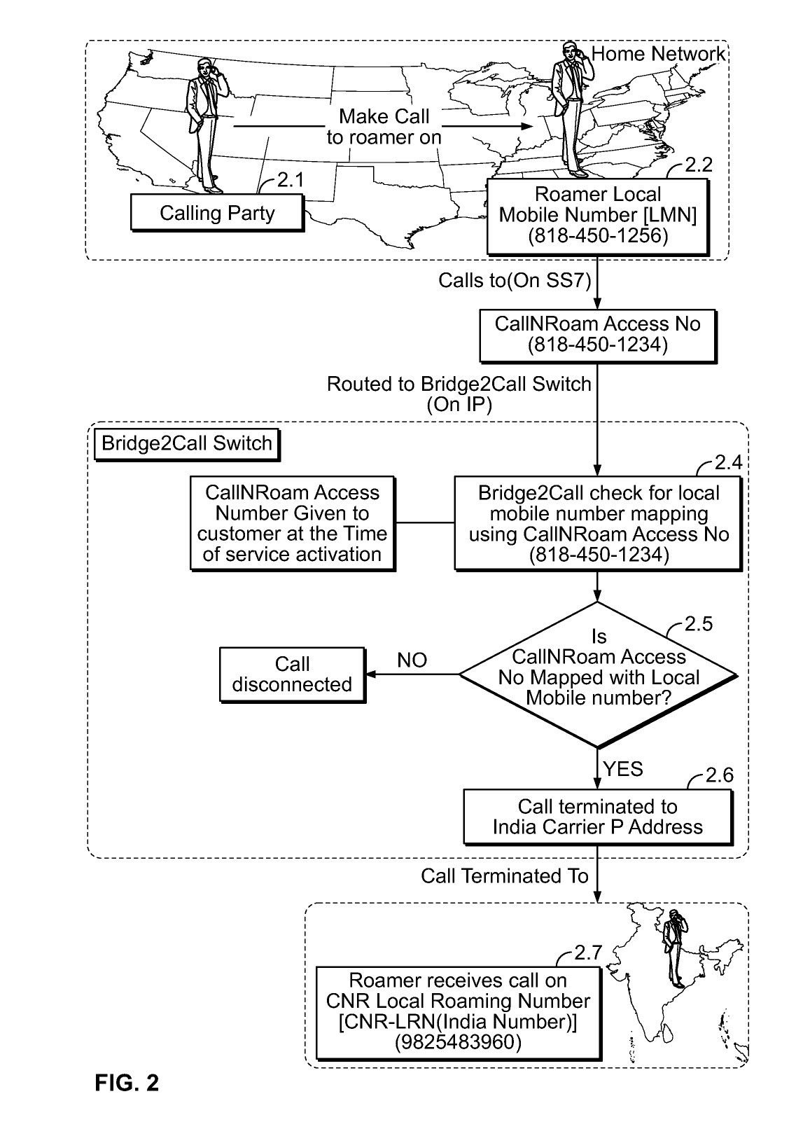

FIG. 2 shows a schematic diagram of how an incoming call would be routed to a roamer when in a foreign country, hereinafter the incoming voice call service. The Incoming call Service and its function in the unique and inventive manner is numerically described as follows:
2.1 In this step, call initiated from roamer home network and calling party dial on roamer local mobile number [LRN-US Number], for example,
Local Mobile Number of Roamer is: 818-450-1256
Home Network: US
2.2 Call forwarded to roamer CallNRoam-Service Access number via SS7 network.
Call forwarded on CNR-SAN: 818-450-1234.
2.3 Call forwarded on roamer CNR-SAN and then routed to Bridge2Call Switch via IP.
2.4 Bridge2Call Switch verifies the mapping details that have been done between CNR-SAN and roamer Local Mobile Number.
2.5 * If CallNRoam-Service Access number (CNR-SAN) not mapped with Roamer Local Mobile number then call disconnected.
* If CallNRoam-Service Access number (CNR-SAN) mapped with Roamer Local Mobile number then flow directed to ‘2.6’
2.6 Call terminated on Foreign network carrier IP, for example,
Roamer Foreign Network: India
Roamer CallNRoam Local Roaming Number (CNRLRN): 9825483960
2.7 Roamer receives a call on CallNRoam Local Roaming Number (CNRLRN), that is 9825483960.

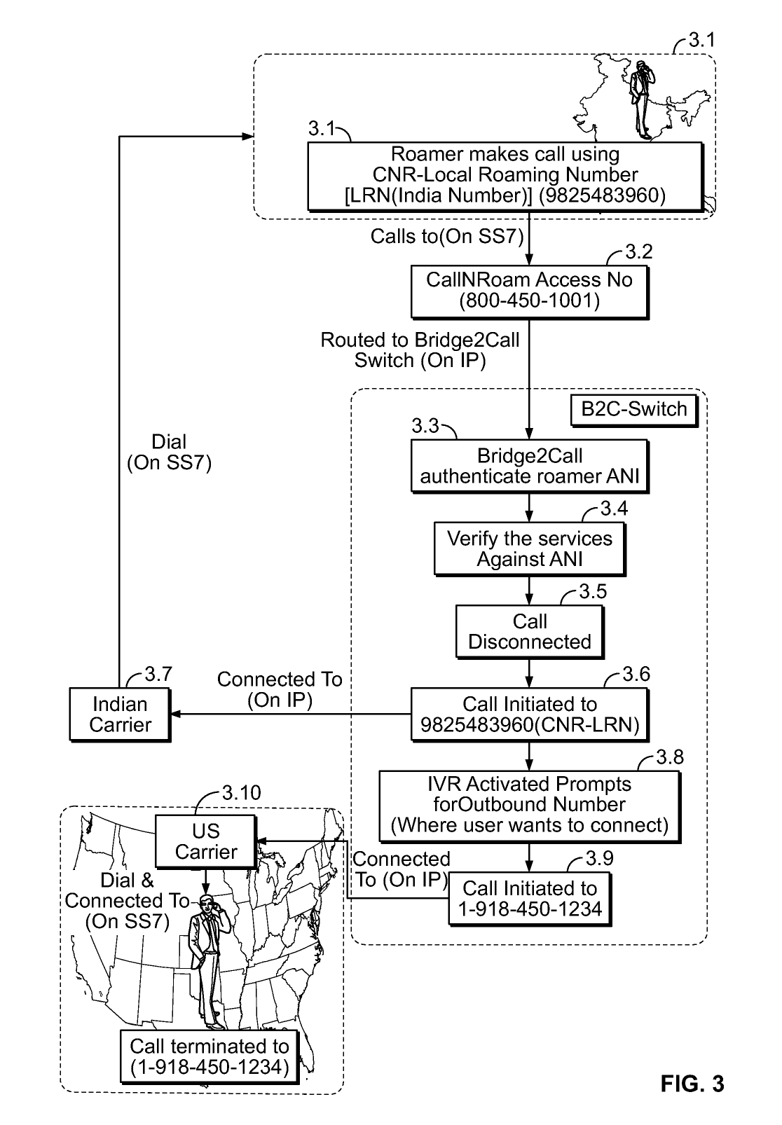

FIG. 3 shows a schematic diagram of how an outgoing call would be made by the roamer, the outgoing voice call service. The Figure shows the operational schematic diagram of the Open Outbound Access Number [OOAN] outgoing voice call service and its function in the unique and inventive manner is numerically described as follows:
3.1 In this step, call initiated from roamer foreign network and roamer makes call on Open Outbound Access Number [OOAN] using his/her CallNRoam Local Roaming Number [CNRLRN]. For example,
Foreign Network: India
CallNRoam Local Roaming Number of Roamer is: 9825483960
Open Outbound Access Number is: 1-918-450-1234
3.2 Call forwarded to roamer CallNRoam-Service Access number (CNR-SAN) via SS7 network. Call forwarded on CNR-SAN: 800-450-1001.
3.3 Call forwarded on roamer CNR-SAN and then routed to Bridge2Call Switch via IP and switch authenticates roamer ANI details.
3.4 B2C switch also verify the service if ANI authentication successes.
3.5 Switch disconnects the call after authenticating and verifying ANI and service respectively.
3.6 Call Initiated by B2C switch for to connect with roamer on his/her CallNRoam local roaming Number (CNRLRN). CallNRoam Local Roaming Number of Roamer is: 9825483960.
3.7 Initiated call connected to Foreign Network carrier IP via IP.
* Foreign Network: India
Foreign Network carrier dials on roamer CallNRoam-Local Roaming Number (CNRLRN) and connect via SS7.
* CallNRoam Local Roaming Number of Roamer is: 9825483960
3.8 IVR activated when Initiated call successfully connected to roamer CallNRoam Local Roaming Number and keep call on hold.
CallNRoam Local Roaming Number of Roamer is: 9825483960
IVR Prompt roamer for entering outbound where s/he want to call.
3.9 Again Call Initiated by Bridge2Call switch to connect roamer on outbound number dialed by roamer on ‘IVR Prompt’
* Open Outbound Access Number entered by Roamer is: 1-918-450-1234
3.10 Initiated call connected to Home Network carrier IP via IP.
Foreign Network: India
Home Network: US
Home network carrier dials on roamer Open Outbound Access Number and connect via SS7.
open outbound access number entered by Roamer is: 1-918-450-1234
3.11 Call terminated on Open outbound access number (i.e. dialed by roamer) and roamer will be able to utilize the voice call service using CallNRoam Local Roaming number. As Result Call made using roamer-CallNRoam Local Roaming Number (CNRLRN) connected to Open Outbound Access Number.
CallNRoam Local Roaming Number: 9825483960 (India Number) Connected to
Open Outbound Access Number: 1-918-450-1234 (US Number)

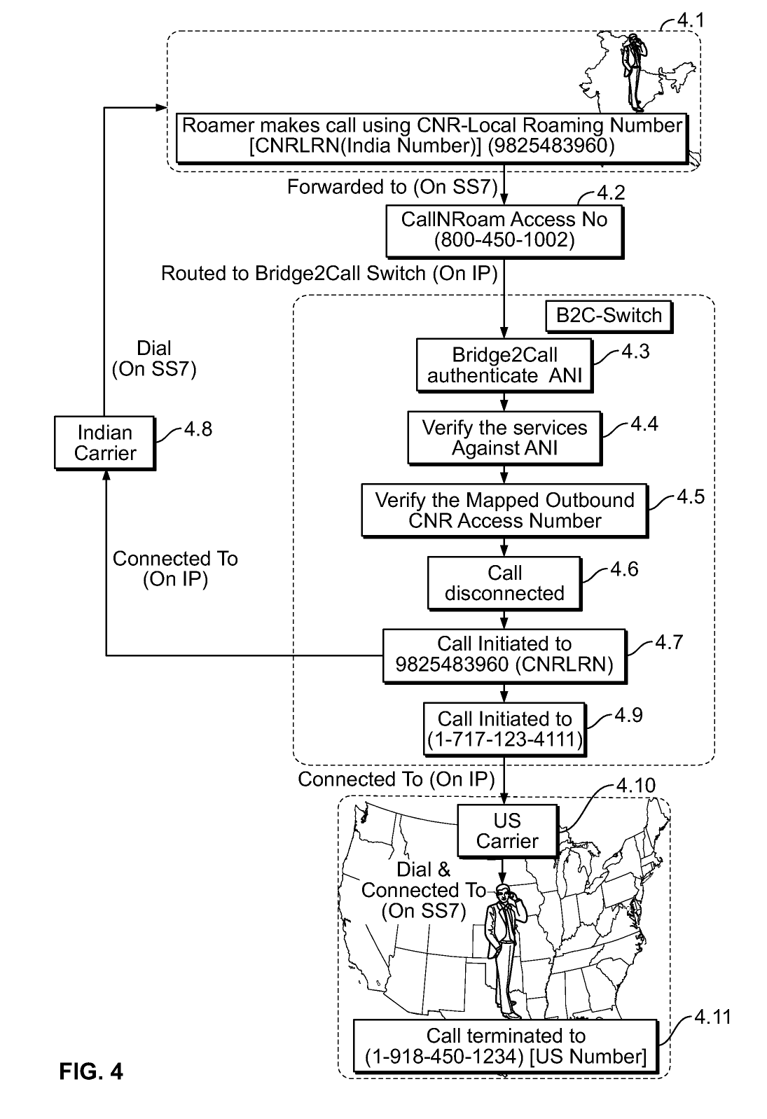

FIG. 4 shows a schematic of how the roamer would use a mapped outbound access number (MOAN) to make and execute the long distance call. The figure shows the operational schematic diagram of the Mapped Outbound Access Number [MOAN] outgoing voice call service and its function in the unique and inventive manner is numerically described as follows:
4.1 In this step, call initiated from roamer foreign network and roamer dial on Mapped Outbound Access Number [MOAN] using his/her CallNRoam Local Roaming Number [CNRLRN]. For example,
Foreign Network: India
CallNRoam Local Roaming Number of Roamer is: 9825483960
CallNRoam Mapped Outbound Access Number of Roamer is: 1-717-123-4111
4.2 Call forwarded to roamer CallNRoam-Service Access number via SS7 network.
Call forwarded on CNR-SAN: 800-450-1002
4.3 Call forwarded on roamer CNR-SAN and then routed to Bridge2Call Switch via IP and switch authenticates roamer ANI details.
4.4 Bridge2Call (B2C) switch also verify the service if ANI authentication successes.
4.5 Switch verifies the Mapped Outbound Access Number defined by roamer for making outbound call.
4.6 Switch disconnects the call after authenticating and verifying ANI and service respectively
4.7 Number of Roamer is: 9825483960 Call Initiated by Bridge2Call (B2C) switch to connect with roamer on his/her CallNRoam local roaming Number (CNRLRN).
CallNRoam Local Roaming
4.8 Initiated call connected to Foreign Network carrier IP via IP.
Foreign Network: India
Foreign Network carrier dials on roamer CallNRoam-Local Roaming Number (CNRLRN) and connect via SS7.
CallNRoam Local Roaming Number of Roamer is: 9825483960
4.9 Again Call Initiated by Bridge2Call (B2C) switch to connect roamer to dialed (i.e. Mapped) outbound number.
CallNRoam mapped outbound access number entered by Roamer is: 1-717-123-4111
4.10 Initiated call connected to Home Network carrier IP via IP.
Foreign Network: India
Home Network: US
Home network carrier dials on roamer Mapped Outbound Access Number and connect via SS7.
Mapped Outbound Access Number entered by Roamer is: 1-717-123-4111
4.11 Call terminated on Mapped outbound access number of roamer and roamer able to utilize the voice call service using CallNRoam Local Roaming number. As Result Call made using roamer-CallNRoam Local Roaming Number (CNRLRN) connected to Mapped Outbound Access Number (MOAN).
CallNRoam Local Roaming Number: 9825483960 (India Number) Connect to
Mapped Outbound Access Number: 1-717-123-4111 (US Number)

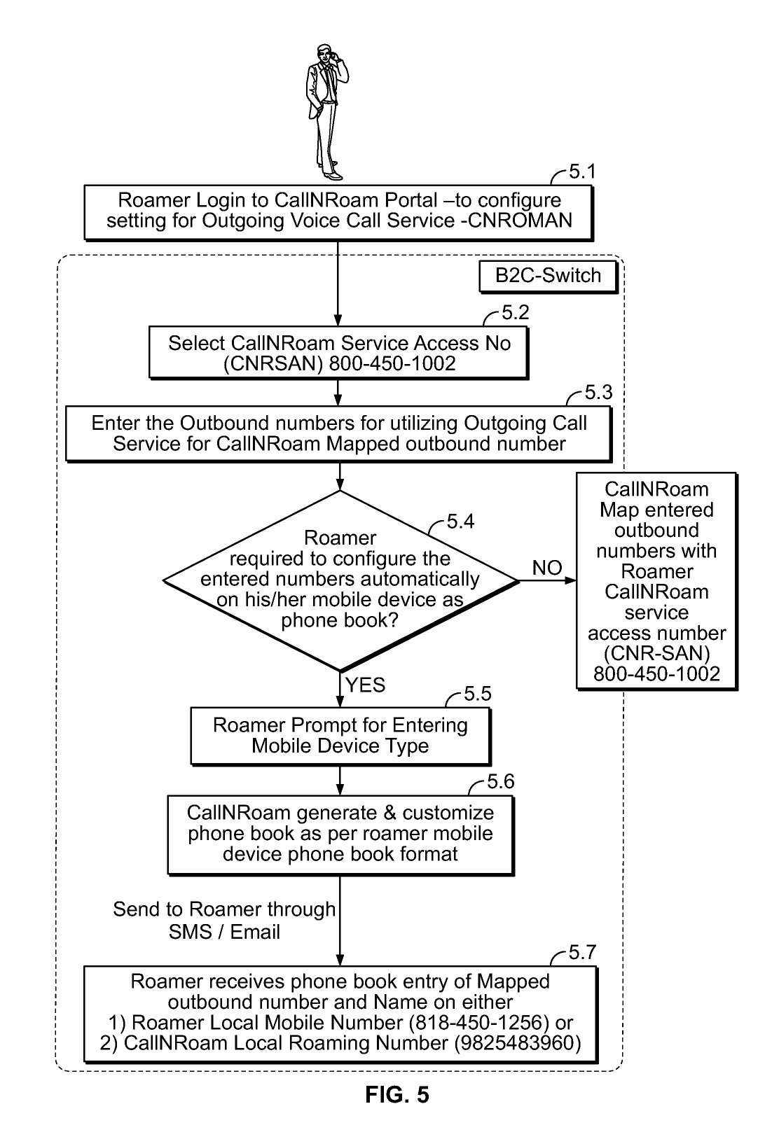

FIG. 5 a schematic of how the roamer can program some elements of the present invention. The figure shows the operational schematic diagram of the Provision service and its function in the unique and inventive manner, the provision service is numerically described as follows:
5.1 In this step, Roamer login to CallNRoam web portal for configure the outbound numbers for Utilizing Outgoing Voice service-for MOAN (For details refer ‘MOAN Out Going Voice Call Service’)
5.2 Select the CallNRoam-Service Number for which roamer want to map numbers for outgoing Voice Call Service using portal user interface. For example,
Roamer selected CallNRoam Access Number (CNR-SAN) as: 800-450-1002
5.3 Define the number list by entering outbound numbers that roamer wants to map with entered CallNRoam Service Access Number. For example, Roamer enters following numbers
1) 818-450-4531
2) 1-717-123-4111
3) 918-450-4531
4) 717-345-4320 . . . and so on
5.4 Roamer prompts for Availing phone book for entered on roamer mobile device.
If roamer respond as ‘No’ then entered outbound number mapped with roamer CallNRoam Service Access Number.
If roamer respond as ‘Yes’ then flow directed as mention in ‘5.5’
5.5 Roamer prompt for mobile device on which he/she wants to receive phone book entry for entered and mapped outbound number.
5.6 Bridge2Call switch generate the phone book entry for entered outbound numbers along with name and customize the phone book format automatically (as mobile device used by roamer).
5.7 Send the generated phone book to roamer via email or Short messaging service, either on roamer 1) Local Mobile Number or on 2) CallNRoam-Local Mobile Number.

Glossary of Terms

### Term Definition

Roamer CallNRoam customer, who is availing International Roaming Service Calling Party Person making a call to Roamer
CNRTFAN CallNRoam Toll Free Access Number
(Used for Service activation)
PIN Personal Identification Number of Roamer
(Given to Roamer on purchasing of CallNRoam Service, which is further used for roamer identification and it is of 12 digits)
RLMN Roamer Local Mobile Number
(Roamer Local Mobile Number provided by home network)
CNRSAN CallNRoam Service Access Number
(Given to Roamer on activation of service, for utilizing CallNRoam-International Roaming Service)
CNRLRN CallNRoam Local Roaming Number
(Given to Roamer from CallNRoam to receive [Incoming Voice Call]/make a call [Outgoing Voice Call] when roamer is roaming around the foreign network)
OOAN Open Outbound Access Number
(This number is used for outgoing voice call service by roamer and this number is not defined in outbound calling number list i.e. entered by roamer for international calling)
MOAN Mapped Outbound Access Number
(This number is used for outgoing voice call service by roamer and this number is defined in outbound calling number list i.e. defined by roamer for international calling)

The CallNroam system and method offers a dual advantage, to the general public and to local operators, and it works as a cost saving method as an ideal combination.

The system is using majority of the portion of the worldwide infrastructure facility without expending up on it and at the same time it adopts the principle of low cost usage with the help of a highly efficient call transfer system. For efficient operation of the roaming services the System Apparatus B2C with the help of intelligence of software Application method and also works as international calling services supplement offering an effective distribution system and greatly reducing the usage cost of roamer/user.

Most inventive, effective and efficient part is B2C Switch, which with the help of software program intelligence netting the roaming services of international calling in one thread which may help to reduce the cost of usage and also improving the overall efficiency and give most desirous results of prompt service with lesser utilization of efforts and therefore the CallNRoam system and method is more convenient, useful, economical, applicable and preferable then the prevailing conventional regular roaming systems and the same which envisage the saving of remarkable amount of usage cost at great notable extent. It is also preserve the soul identity of the personal number of the roamer. The calling party by mere dialing the roamer's original number may contact to roamer wherever the roamer is. At the same time roamer may use his own calling card and/or may use a new card from the local operators of the country more efficiently without escaping the original number wherever he roaming. Such facility may increase the international market of local operators without any expenses and extra efforts outside their country.

In the present era when society is using and enjoying the modern communication systems by paying high value with having some deficiency of usage, present invention is most convenient, effective and cheapest system with support of most calculative and accurate software application which mapping the communication of the Roamer with preserving his identity in another country and the said facility has been available without paying any extra cost and with the help of the software method the Roaming charge will cost very lower and to calculate the same without any fault in most accurate way and with this facility the Roamer may able to utilize more time by saving high roaming charges.

Thus the novel invention is a technology based on B2C (bridge to call) switch system along with the method of use. The method of use being a more efficient, cost effective and affordable solution than the international calling roaming services presently being provided. The efficiency and accuracy ratio is far greater than the conventional international calling systems presently being used in commerce. The present invention is an alternative and/or substitute for the prevailing roaming services which are expensive, complex, and ruin the identity of the roamer. While working as a roaming supplement unit offering an effective distribution system having intelligent controlling of the B2C system with method of Software programming which may affect positively on the costing and market environment and automatically guarantee the low usage cost and automatic creation of new market. The present invention an alternative or substitute of the present roaming services prevailing in the market. The invention results in reduction of usage costs while improving the overall efficiency and affectivity of the roaming services being provided. Therefore, because prevailing roaming services are more expensive, the present invention is a more effective, convenient, and cheaper mode of communication. In addition, the present invention is user friendly.

For CallNroam system and method Bridge2Call (B2C) is the solution and complete platform for long distance call while Roaming outside the country. The complete logic, technicality and idea behind the inventive part of the B2C with brain intelligence of a software application in the form of computer program and which create the multi dimension force and a visionary effect in two fold. It facilitates the Roamer in international calling and creates employment as well. The Brief facets of the Bridge2Call (B2C) is described here as follows:

### Key Benefits & Key Feature List

Web Based Administration
Advance Tariff Management
Prepaid Card Management
SIP Registrar Support
IVR Management
DID Management
SOAP-XML Support for Third Party Integration
Payment Gateway Support
SMS Gateway Support
Easy User Management
Multiple Carrier Support
Various Routing Type Support (LCR,Priority,Blocking)
Web Based Reporting System
Email Based Reporting System
Web Services module for services like Web-Portal, Customer Self-care
Modular Architecture
Carrier Grade Reliability

### Subscriber Management

Various subscriber support like Prepaid Cards, SIP Users, Conference Users
Subscriber Plans to manage set of users and services.
Prepaid Top-Up System
Denomination with Face Value and Top Up Value
Control Number (Serial No) for Unique Identification Subscriber
Activation and Deactivation of Subscriber based the control number of PIN
Expiration of cards after given time interval from First date of use.
Voucher Management for Prepaid Top-Ups
Multiple Denomination Support with Expiry.

### Call Module

IVR Based Out Bound Call Support
ANI Call Back Support for Out Bound Calls
SIP Registrar Support for Direct Calling from Soft-Phones and ATA
SMS Call Back Support
Simultaneous Call Support
Cut through Dialing Support
SIP registrar Support
SIP trunking Support
DID number forwarding

### IVR Module

Optimized IVR for Calling and Support
Multi-lingual prompts configurable per access number.
PIN Based and PIN Less Calling.
Credit Balance Prompt at successful authentication.
Alert of last minute duration
Real time disconnection for insufficient balance call
Limit number of “TRIAL” on IVR for outgoing calls
Follow on call
Speed Dialing
Limit on Maximum Duration of calls
Last Destination Redial

### Tariff Module

Import & Export Rates for Tariff in CSV format
Telescopic Rate Support
Special Rate support for Holiday, Weekend, Time Period of Day.
Complex Rate formulation using Complex Rate Formula
Roaming Rate Support (Based on ANI pattern)

### Call Metrics Module

Taxation per call
Connection Fee per call
Disconnection Fee per call
Maintenance/Service charges /Recurring configuration that are applied by system at fix interval configured in days
Toll Free Surcharge in case of call is from the TOLLFREE number
All above charges are configured at three levels: Product, Batch of product and Call Plan (Destination wise).

### Carrier Module

Call Tracking among Multiple Carrier Rate Management
Carrier Group Management
Import & Export Rates in the CSV format
Priority based routing
Least cost routing
Block List Management
Multiple Carriers

### DID Number Management Module

IP Based Authentication for for DID
Language Setting per Access Number.
Rate Setting for Toll Free Number for better cost management including Payphone cost.
Access number grouping for utilizing while making the Product for calling card.
Roaming DID Support

### User Management Module

Access Control based user administration so same web interface can be utilized by different departments of the company.
Department wise Access Control

### Third Party Integration Module

Web Service Support for Third Party Integration
SOAP-XML Support
Service over HTTPS

### Report Module

Inquiry report for the various customer specific queries
Detail Traffic Reports Based On Product, Carrier & DID, Batch
Daily Load Report
Traffic Summary Report
First Use Card Report
Live Call Monitoring
Email Based Reports

### Billing Module

Real Time Billing integrated in the system.
Reseller Billing based on Activation of card
Reseller Billing based on First use of the card
Invoice Management for Resellers
Real Time Credit Management For the Resellers

### Special Offer Module

Holiday Offers
Volume Offers
Call Offers
Family And Friend Offer Module
Admin Fee for the Offers
Separate Balance for Offers
Separate Rate for Offers

### Customer Self-Care Module (For End Users)

Online Recharge
Speed Dial
Family & Favorite list
Call Detail Record
Speed Dial list
PIN Less Settings
SSL Security
Profile Management
Refer-A-Friend

### Support Web Panel (For Customer Care Executives)

Support page for Customer Care Executives
Reversal of Call Charges
ANI registration
Speed Dial Management
Offer Support
Call Detail Records

### Reseller Module

Account Management
Subscriber Management(Using ANI)
Subscriber Recharge Facility(Using ANI)
Integrated With Payment Gateway to Real time Credit Update
Account Statements
Reports

### E Commerce Module

Centralize Management of the Online Prepaid Business
Payment Gateway Support
Integrated with Admin Panel
Template Support
SSL Secured

### Modular Architecture for Scalability

Sip Proxy Module
Switch Module
Database Module
Application Server Module

### Security

SSL for the Web Access
Firewall at each node
ACL based access of the system

### POSSIBLE OTHER MODULES and Services

Call Shop Module
Class 5 Services Modules (Voice Mail, Call Forwarding etc)
Conferencing Module
Multi Currency Support

The above mentioned features expressly show the most effective usage parts of the deep mechanisms of the CallNRoam system via B2C switch having threading of computer software Application method working as system controller and also gives the specification of the strategy of the device and also shows that where which application is fixed and how it works/applied. Moreover it also shows the main aspect in this methodical system regarding the roaming services associated with other allied services which is used in multipurpose way in every aspect as most effective parts. This service is enhanced by associating two incredible features with outgoing voice call service for CNRMOAN. They are as mentioned below:
A. CallNRoam also facilitates roamer to create a list for selective numbers where s/he calling frequently. After defining a number list, CallNRoam automatically generates the phone book/contact book and also customize this as per roamer's requirement (as per handset used by roamer). Due to this fabulous feature, it is not mandatory for roamer to dial number for outgoing calling every time and that make out going voice call service for MOAN process simple and easy.
B. CallNRoam also generates the Business Cards for defined number (i.e. defined by roamer) and send to Roamer-CallNRoam Local Roaming Number (CNRLRN) through short messaging service (SMS) or Email.

By applying the system and method one gets the unique and wonder results of getting most effective cost reduction and positive effects of perfect communication system in the form of roaming facility.

An advantage of the present invention is that it provides a unique worldwide telecommunication service that provides international roaming services to users by enhancing the mobility of their incoming and outgoing voice calls at very nominal usage charges.

Another advantage of the present invention is that it creates an efficient long distance telecommunication service that blurs international boundaries in a cost efficient manner.

A further advantage of the present invention is that it creates a complete platform that allows its operators to initiate and create their own retail calling card businesses.

Still a further advantage of the present invention is that it provides a unique thread that international roaming facilities avail when connecting to users of the thread, thereby reducing the costs of roaming when the users are not in the home country wherein the thread originated, the unique thread being associates to a specific telephone number.

Although the present invention has been described in considerable detail in reference to certain preferred versions thereof, other versions are possible. Therefore, the spirit and scope of the claims should not be limited to the description of the preferred versions contained herein.

What is claimed is:

1. An international number transfer device, comprising:
a user interface;
a TDM switch that connects to the user interface;
an access number server that connects to the TDM switch;
a system having an SBC (session border controller), a database, a call session controller, and an application that manages roamers unique identifiers, the system connects to the TDM switch; and
a termination carrier that connect to the system.

2. The international number transfer device of claim 1, wherein the application allows roamers using the device to be assigned one unique identifier that can be accessed throughout the world to make in and outgoing calls.

3. A method of using the international number transfer device of claim 2, comprising the steps of:
providing the device;
instructing a user of the device to activate the device ;
assigning a unique identifier to the user; and
activating the device so that the user can make incoming and outgoing calls from anywhere in the world using the unique identifier.
